(19) United States
(12) Patent Application Publication
(10) Pub. No.: US 2004/0125956 A1
(43) Pub. Date: Jul. 1, 2004

(54) Location document system

(76) Inventors: David D. Heiderscheit, Crystal Lake, IL (US); Gerry John Gutowski, Palatine, IL (US); Jim E. Malone, Barrington, IL (US)

Correspondence Address: VEDDER PRICE KAUFMAN & KAMMHOLZ, 222 N. LASALLE STREET, CHICAGO, IL, 60601, US

(21) Appl. No.: 10/334,852

(22) Filed: Dec. 31, 2002

(51) Int. Cl. H04K 1/00

(52) U.S. Cl. 380/258; 380/270

(57) ABSTRACT

A method and apparatus for managing documents incorporates the use of position or location information. In one example, documents (310) include one or more location attributes (312) that are used by a receiving device (200), in conjunction with position information provided to or determined by the receiving device (200), to determine operations that may be performed on the document (310). Alternatively, based on the location attributes (312) and the position information, the device (200) may determine that certain operations are not permitted to be performed on the document. Further still, display of selected portions of the document (310), or access to the document (310) may be likewise controlled in this manner. In one embodiment, the receiving device (200) is a wireless mobile device such as a cellular telephone or the like.

### FIELD OF INVENTION

The present invention relates to document management systems and, in particular, to a document management system that incorporates the use of position or location information to determine operations that may be performed on documents.

### BACKGROUND OF THE INVENTION

Various documents management systems are know in the art. In such systems, various mechanisms are provided to control privacy and security of documents within the system. For example, much effort has been dedicated recently to so-called digital rights management (DRM) techniques. Generally, DRM techniques address the enforcement of rights such as printing, copying, editing, etc. corresponding to digital documents. In general, a document within such systems may comprise any data or information that may be represented in a digital format and that may be operated upon by a suitable document application.

In general, prior art document management systems provide security and privacy based upon verifiable characteristics such as the use of a proper password or other identification. To date, however, document management systems have not incorporated the use of position or location information. As such, it would be advantageous to provide a document management system that incorporates the use of location or position information.

### BRIEF DESCRIPTION OF THE DRAWINGS

FIG. 1 is a block diagram of a wireless communication system in accordance with an embodiment of the present invention.

FIG. 2 is a block diagram of a receiving device in accordance with the present invention.

FIG. 3 is a schematic illustration of processing of a document by an application in accordance with an embodiment of the present invention.

FIG. 4 is a flow chart illustrating a method in accordance with an embodiment of the present invention.

FIG. 5 illustrates the use of position information in accordance with an embodiment of the present invention.

### DETAILED DESCRIPTION OF THE PREFERRED EMBODIMENTS

The present invention provides a method and apparatus for implementing a document management system that incorporates the use of position or location information. In particular, documents in accordance with the present invention comprise one or more location attributes that are used by a receiving device, in conjunction with position information provided to or determined by the receiving device, to determine operations that may be performed on the document. Alternatively, based on the location attributes and the position information, the device may determine that certain operations are not permitted to be performed on the document. Further still, display of selected portions of the document, or access to the document may be likewise controlled in this manner. Virtually any type of position information may be used in conjunction with the present invention, including, but not limited to, position information derived from time-of-arrival type processing, or, in the case of a cellular communication system, position information derived from cell sites identification. In a presently preferred embodiment, the receiving device comprises a wireless mobile device such as a cellular telephone or the like. Using the techniques described herein, the present invention facilitates the deployment of a document management system that incorporates the use of location or position information and thereby provides a greater degree of flexibility in which documents which may be used and protected.

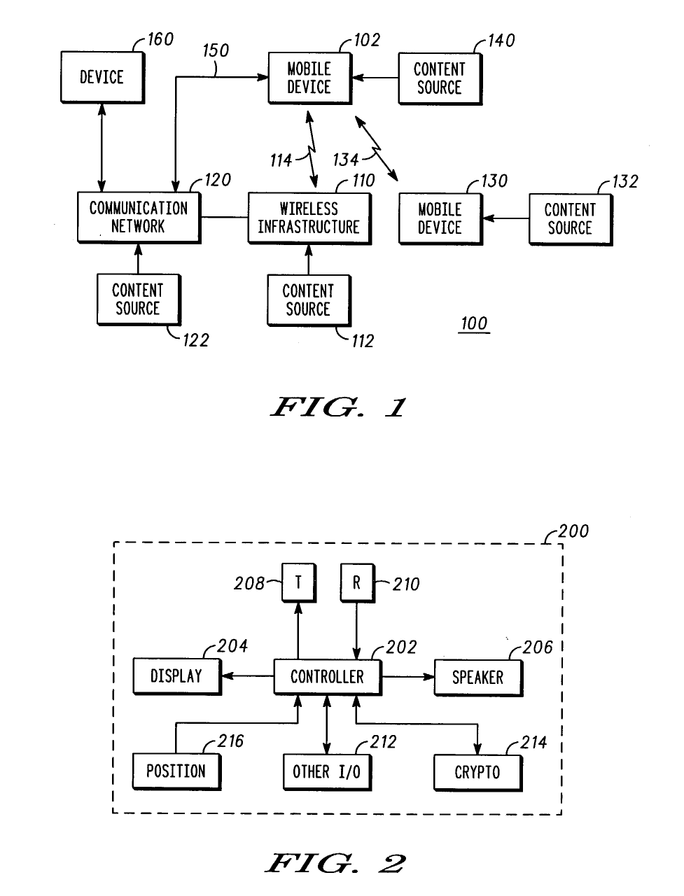

The present invention may be more readily described with reference to FIGS. 1-5 below. Referring now to FIG. 1, a wireless communication system 100 including at least one mobile (or receiving) device 102, 130 in wireless communication with a wireless network or infrastructure 110 or each other via at least one wireless channel 114, 134. The mobile devices 102, 130, illustrated in greater detail below with reference to FIG. 2, may include any wireless communication devices, such as cellular phones, two-way radios, wirelessly-enabled personal digital assistants or computers, etc., at least capable of receiving documents in accordance with the present invention. Although the present invention is primarily applicable to mobile receiving devices, it may be beneficially applied to any type of receiving device, including non-mobile devices 160 such as traditional, landline telephones, desktop computers and the like. The wireless infrastructure 110 includes those elements necessary to support such wireless communications, as known in the art, the particulars of which elements will vary according to the type of system 100 employed. Such elements typically include base stations, resource controllers, transcoders, switches, and a variety of other elements known to those having ordinary skill in the art. The wireless channels 114, 134 are likewise dependent upon the nature of the system 100 implemented. In general, however, the wireless channels 114, 134 may include any wireless resources such as radio frequency (RF) channels, infrared channels, etc. supporting any suitable modulation protocol (e.g., frequency modulation, amplitude modulation, etc.) and/or access protocol, such as frequency-division multiplexed (FDM), time-division multiplexed (TDM) or code-division multiplexed (CDM) protocols. Note that the wireless channel labeled with reference numeral 134 may be provided in support of mobile-to-mobile communications such that the mobile devices 102, 130 may communicate with each other without intervention of the wireless infrastructure 110.

FIG. 1 particularly illustrates the manner in which content (i.e., documents in accordance with the present invention) may be provided to, for example, a first mobile device 102 from a plurality of content sources 112, 122, 132, 140. The content sources 112, 122, 132, 140 may comprise any device or combination of devices capable of supplying documents in accordance with the present invention. Documents in accordance with the present invention may comprise any data or information that may be represented in a digital format and that may be operated upon by a suitable document application. For example, a document may include, but is not limited to text, sound, images and video and may delivered in any suitable format such as DVD, digital CD, MP3 or other suitable formats.

Regardless of the actual types, documents may be provided to the first mobile device 102 from a variety of sources. For example, a first content source 112 may be coupled to the wireless infrastructure 110 such that content from the first content source 112 may be provided to the first mobile device 102 via a wireless channel 114. Alternatively, the first mobile device 102 may be coupled to a communication network 120 via a direct connection 150 or via the wireless infrastructure 110. In this manner, a second content source 122 may be coupled to the first mobile device 102. In practice, the communication network 120 may comprise a public network such as the Internet or World Wide Web, a private network such as a corporate intranet, or a combination of public and private network elements. Regardless, where the content source 112, 122 is coupled to the first mobile device 102 via an intervening network, the content source 112, 122 may be embodied by a computer-based server platform of the type well known in the art. In yet another embodiment, a third content source 132 may be coupled to the first mobile device 102 via another mobile unit 130 and wireless channel 134. A fourth content source 140 may be coupled directly to the first mobile device 102. Content sources 132, 140 coupled directly to mobile devices 102, 130 may comprise memory cards or similar storage devices having the desired audio and video content stored thereon. Furthermore, where the receiving device is a non-mobile device 160, it may be coupled to a suitable content source 122 via the communication network 122, or directly coupled to the content source (not shown).

Referring now to FIG. 2, a more detailed illustration of a receiving device in accordance with the present invention is shown. In particular, the receiving device 200 comprises a controller 202, a display 204, a speaker 206, a transmitter 208, a receiver 210, other input/output devices 212, a cryptographic component 214, and a position determination component 216. As shown in FIG. 2, the receiving device 200 operates under the control of the controller 202 that may comprise a device capable of maintaining state information including, but not limited to, a microprocessor, microcontroller, programmable logic, an application specific integrated circuit, or combinations thereof. Where the controller 202 comprises a microprocessor or similar device capable of executing stored instructions, such instructions are preferably stored in a suitable storage device such as random access memory (RAM), read only memory (ROM) or other similar volatile or non-volatile storage devices. The display 204 may comprise any conventional display device such as a liquid crystal display or other similar device. The speaker 206 may comprise any conventional device for reproducing sound output as known in the art. The transmitter 208 comprises any device capable of transmitting data via a suitable medium under control of the controller 202. In particular, the nature of the transmitter 208 is particularly dependent upon the environment in which the receiving device 200 is operating. For example, in a presently preferred embodiment, the receiving device 200 comprises a wireless device such as a portable radio or cellular telephone. In this case, the transmitter 208 comprises a wireless transmitter capable of modulating a wireless carrier as known in the art. In a similar vein, the receiver 210 may comprise a wireless receiver capable of demodulating a wireless carrier in the case where the receiving device 200 comprises a wireless device. However, it is understood that the present invention may be applied to receiving devices other than wireless devices. For example, the receiving device 200 may comprise a desktop personal computer or the like that communicates with other devices via hardwired communication paths. The other input output devices 212 include all other mechanisms by which signals are provided to/from the controller 202. For example, the receiving device 200 may include a microphone, touch screen, alphanumeric key pad, various buttons, soft keys, switches, dials or other user-actuable devices as known in the art. Further still, a data port may be provided such that various types of information may be input directly to the controller 202. Likewise, various other types of output devices may be employed, such as light emitting diodes, enunciators, vibrators and the like. The nature and extent of the other input/output devices 212 is a matter of design choice, and the present invention need not be limited in this regard. The cryptographic component 214 comprises any mechanism capable of encrypting and decrypting data, as known in the art. Those having ordinary skill in the art will recognize that the cryptographic component 214 may be implemented using hardware or software or a combination thereof. Finally, the position determination component 216 may comprise any device or sources capable of providing location or position determination data to the controller 202. As known in the art, various types of position determination devices may be used. For example, time-of-arrival devices such as global positioning system (GPS) receivers and the like may be used. In such systems, positions or locations are expressed in terms of latitude/longitude coordinates. Alternatively, where a wireless communication system is employed, such as a cellular communication system, position information based on cell site identification may be employed. In yet another embodiment, where the receiving device is not mobile, the position determination component 216 may simply comprise a hard coded data entry concerning the position or location of the device. Again, the manner in which the position or location information is expressed is a matter of design choice; in addition to the latitude/longitude coordinates or cell site identifications mentioned above, mechanisms as simple as street addresses could be equally employed.

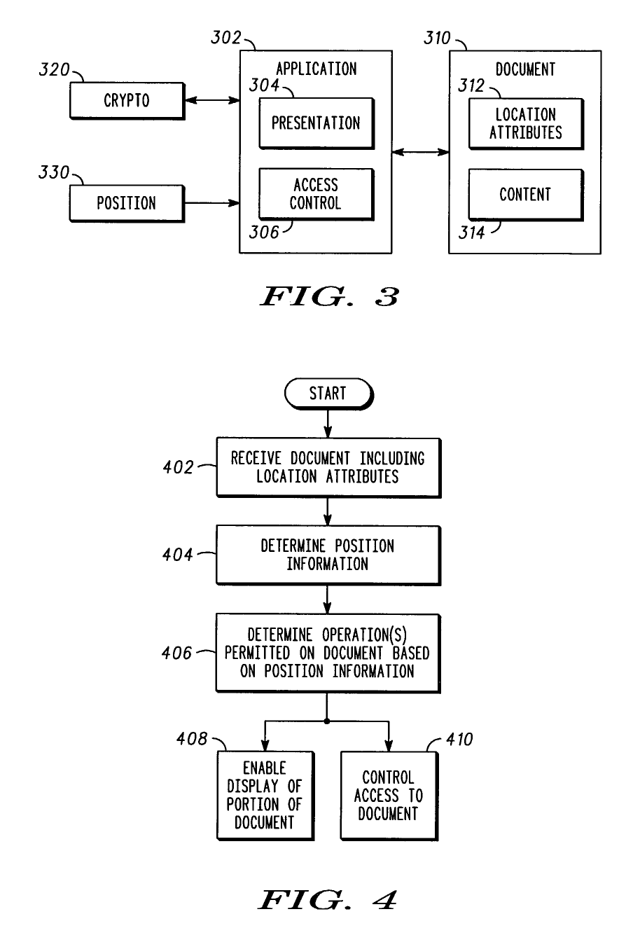

Referring now to FIG. 3, a schematic illustration of the operation of an application in conjunction with a document in accordance with the present invention is illustrated. In particular, the application 302, which may comprise any mechanism through which a document 310 may be manipulated, includes at least a presentation component 304 and an access control component 306. An application may include for example, Java applications, J2ME applications, Scripts and an application reader may include Web browsers an other suitable applications or application readers. The document 310 includes any data or information capable of being digitally represented, i.e., content 314, in addition to one or more location attributes 312. As used herein, location attributes 312 may comprise any data or information that may be used by an application to determine the types of operations that may be performed on the document 310 based on the position information of a device implementing the application. For example, a location attribute may comprise data illustrating a particular position or location, or groups of positions or locations (i.e., areas), in which certain operations may be performed. Alternatively, or in addition, the location attributes 312 may comprise one or more rules that define a set of conditions that are to be assessed based on the position or location information. As such, location attributes include data representing a document zone and permission assigned to the document for that zone. Permissions include but are not limited to viewing, editing, deleting, duplicating or other desired attributes. The content 314 comprises the actual data or information to be conveyed by the document 310.

The presentation component 304 of the application 302 controls what portion of the content 314, if any, is to be displayed based on the position information 330. Similarly, the access control component 306 controls the level of access to be given to the content 314 based on the position information 330. For example, within one area, access may be entirely denied to the content 314 of the document. Alternatively, within another region or area, access may be provided to a certain portion or subset of the content 314. Further still, in yet another region or area, access may be provided to the entire content 314. In one embodiment of the present invention, the access control component 306 may also function to delete the entirety of the document 310 if corresponding conditions mandated by the location attributes 312 are met based on the position information 330. In some instances, the content 314 or portions thereof may be encrypted thereby necessitating the use of a cryptographic process 320 in order to convert the content 314 or portions thereof into a presentable form. Likewise, public key, symmetric key and any suitable trust principles (e.g., utilizing digital certificates) may be applied by the cryptographic component 214 to protect against threats to the cryptographic source 212.

Referring now to FIG. 4, a method in accordance with the present invention is illustrated. The operations described in FIG. 4 are preferably implemented using stored executable instructions executed by an appropriate processing platform in conjunction with suitable hardware devices, as described above. At block 402, a receiving device receives a document or documents including location attributes. Note that the manner in which the document is received is a matter of design choice and the present invention is not limited in this regard. When it is desired to access or operate upon the document, the application executing upon the receiving device, via a position determination component as described above, determines or otherwise ascertains 404 the position information of the device itself. As noted previously, the nature of the position or location information may vary depending on the particular implementation of the position determination component. For example, where a GPS receiver is employed, the position or location information may comprise latitude/longitude coordinates as known in the art. Alternatively, where locations are divided into specific regions or zones, the position or location information may comprise the identification of a particular region or zone.

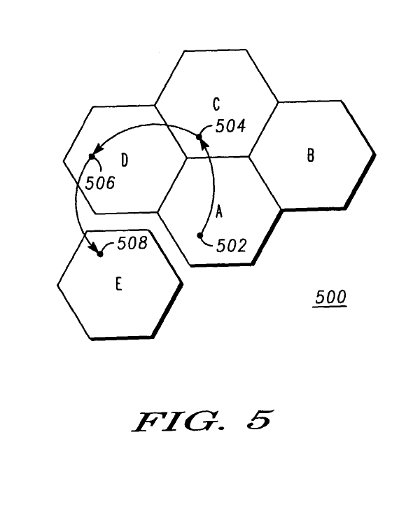

Regardless of the manner in which it is represented, the position information is thereafter used at block 406 to determine any operations that may be permitted on the document. Once again, this is achieved by applying the position information to the location attributes to determine which operations may be permitted. In a presently preferred embodiment, at block 408, display of a given portion of the document is enabled or disabled based on the position information. Additionally, access to the documents may be controlled based on the position information as illustrated at block 410. A particular example of these types of features is further illustrated with reference to FIG. 5 below.

FIG. 5 schematically illustrates a plurality of regions labeled A through E. As used herein, the term regions broadly denotes any area or collection of areas that may be differentiated from each other through the use of suitable position determination devices. For example, the region schematically illustrated in FIG. 5 may correspond to individual areas within a building such as various offices within a single floor or various floors within the building. Alternatively, each of the regions shown in FIG. 5 may correspond to different buildings within a single city. Further still, each of the regions may correspond to separate broad geographic regions such as different cities, states or even countries. Additionally, as illustrated in FIG. 5, various individual regions may be considered as part of a larger system, whereas other regions are excluded from the system. For example, the regions denoted as A through D may be considered part of a system in which at least some basic operations will be permitted on documents associated with those regions. Conversely, the region denoted as E is not part of the system and no operations will be permitted on documents (originating within the system) when attempts are made to operate on those documents within region E.

For example, when a receiving device is operating at a first location 502 within region A, a given document may have location attributes defined therein such that all operations are permitted on the document. As the device continues operation at a second location 504 within region C, the only operation permitted on the document is to allow a user of the device to read the entirety of the document, i.e., so-called “read only” access. At a third location 506 within region D, operations may be further restricted such that the user of the device is only permitted to view the title of the document or similar summary information. Finally, as the receiving device moves out of the system defined by regions A through D and continues operation at a fourth location 508 within region E, no operations of any type are permitted on the document. In an extreme example, any attempts to perform operations on the document while operating within region E may result in the document being deleted entirely. In this manner, the present invention provides a greater degree of control over operations that may be performed on documents based at least in part upon position or location of devices operating on such documents.

The present invention provides a technique for managing documents based at least in part upon the position or location of the device attempting to operate upon the documents. In accordance with the present invention, documents include one or more location attributes that, when compared with the current position or location information of the device, determine what operations, if any, may be performed on the document. In this manner, the amount or type of information to be displayed may be determined, or the level of access to be provided may likewise be determined. A level of control over documents not previously available may be achieved.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense and all such modifications are intended to be included within the scope of present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential features or elements of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

The above detailed description of the invention and the examples described therein have been presented for the purposes of illustration and description. It is therefore contemplated that the present invention cover any and all modifications, variations or equivalents that fall within the spirit and scope of the basic underlying principles disclosed above and claimed herein.

What is claimed is:

1. A method for managing documents, the method comprising:
receiving, by a device, a document comprising one or more location attributes;
determining position information corresponding to the device; and
determining operations that may be performed on the document based on the position information and at least one of the one or more location attributes.

2. The method of claim 1, wherein determining operations that may be performed on the document further comprises:
comparing the position information with the at least one of the one or more location attributes; and
permitting a first set of operations to be performed on the document when the position information compares favorably with the at least one of the one or more location attributes.

3. The method of claim 2, wherein determining operations that may be performed on the document further comprises:
permitting a second set of operations to be performed on the document when the position information does not compare favorably with the at least one of the one or more location attributes.

4. The method of claim 1, further comprising:
enabling presentation of a first portion of the document based on the position information.

5. The method of claim 1, further comprising:
controlling access to the document based on the position information.

6. The method of claim 5, wherein controlling access to the document further comprises deleting the document.

7. The method of claim 5, wherein controlling access to the document further comprises performing a cryptographic process on the document.

8. The method of claim 5, wherein controlling access to the document further comprises enabling password protection of the document.

9. A device comprising:
a receiver configured to receive a document comprising one or more location attributes;
a position determination component; and
a document application configured to receive position information regarding the device from the position determination component,
wherein the document application operates upon the document based upon the one or more location attributes and the position information.

10. The device of claim 9, the position determination component further comprising means for determining position information based on time-of-arrival type processing.

11. The device of claim 9, the position determination component further comprising means for determining position information based on cell site identification.

12. The device of claim 9, further comprising an output component, wherein the document application further comprises a presentation component that presents a first portion of the document via the output component based on the position information.

13. The device of claim 9, wherein the document application further comprises a position-based access control component.

14. The device of claim 13, wherein the position-based access control component deletes the document based on the position information.

15. The device of claim 13, wherein the position-based access control component enables password protection of the document based on the position information.

16. The device of claim 13, further comprising a cryptographic component coupled to the document application, wherein the position-based access control component performs a cryptographic process on the document via the cryptographic component.

17. The device of claim 9 further comprising a wireless mobile device.

18. The device of claim 17, further comprising a cellular telephone.

19. A wireless mobile device comprising:
a processor;
a storage device having stored thereon executable instructions that, when executed by the processor, cause the processor to:
ascertain one or more location attributes in a document;
determining position information corresponding to the wireless mobile device; and
determine operations that may be performed on the document based on the position information and at least one of the one or more location attributes.

20. The wireless mobile device of claim 19, wherein the executable instructions that, when executed by the processor, cause the processor to determine operations that may be performed on the document further comprise executable instructions that, when executed by the processor, cause the processor to:
compare the position information with the at least one of the one or more location attributes; and
permit a first set of operations to be performed on the document when the position information compares favorably with the at least one of the one or more location attributes.

21. The wireless mobile device of claim 20, wherein the executable instructions that, when executed by the processor, cause the processor to determine operations that may be performed on the document further comprise executable instructions that, when executed by the processor, cause the processor to:
permit a second set of operations to be performed on the document when the position information does not compare favorably with the at least one of the one or more location attributes.

22. The wireless mobile device of claim 19, wherein the storage device further comprise executable instructions that, when executed by the processor, cause the processor to:
enable presentation of a first portion of the document based on the position information.

23. The wireless mobile device of claim 19, wherein the storage device further comprise executable instructions that, when executed by the processor, cause the processor to:
control access to the document based on the position information.
